(19) United States
(12) Patent Application Publication
(10) Pub. No.: US 2026/0093334 A1
(43) Pub. Date: Apr. 2, 2026

(54) INFORMATION PROCESSING APPARATUS, CONTROL METHOD THEREFOR, AND STORAGE MEDIUM FOR IMPROVING DISPLAY OPERABILITY

(71) Applicant: CANON KABUSHIKI KAISHA, Tokyo (JP)

(72) Inventor: SAYAKA HARADA, Saitama (JP)

(21) Appl. No.: 19/298,490

(22) Filed: Aug. 13, 2025

(30) Foreign Application Priority Data
Oct. 1, 2024 (JP) 2024-172384

(51) Int. Cl. G06F 3/01; G02B 27/01; G06F 1/16

(52) U.S. Cl. CPC G06F 3/017; G02B 27/0172; G06F 1/163; G02B 2027/0138; G02B 2027/014

(57) ABSTRACT

An information processing apparatus is configured to be communicatively connected to a display device that displays a spatial image including at least one of a real-space image and a virtual-space image and configured to process information communicated with the display device. The information processing apparatus includes at least one processor. The processor is configured or programmed to detect a movement of a hand of a user viewing the spatial image displayed on the display device, as a first detection result, and to detect a position of the hand, as a second detection result, in association with the acquisition of the first detection result. The processor is further configured or programmed to switch a function performed by the display device according to the first detection result and the second detection result.

### BACKGROUND

### Field of the Technology

The present disclosure relates to an information processing apparatus, a method of controlling the information processing apparatus, and a storage medium.

### Description of the Related Art

A technology known as mixed reality (MR), which integrates a real space and a virtual space, enables, for example, operations such as moving a virtual object included in the virtual space on an image of the mixed reality. In this MR technology, a user experiencing the mixed reality can perform operations such as moving a virtual object through their hand gestures, without having to operate a controller held in their hand. The mixed reality image is displayed, for example, on a head-mounted display (HMD) worn on the user's head or on a handheld display held by the user. In the case of a handheld display, when the user performs a gesture with their hand, they may, for example, hold the handheld display with their right hand and perform the gesture with their left hand. For example, Japanese Patent No. 5865615 (JP 5865615 B2) discloses an electronic device that selects an operation mode based on the positional relationship between a face and a hand in an image. Additionally, Japanese Patent Application Laid-Open No. 2012-13514 (JP 2012-013514 A) discloses an information processing apparatus that calculates the three-dimensional position of a subject. The technique for calculating the three-dimensional position of a subject can be applied to the acquisition of the positional relationship between a face and a hand, as described in JP 5865615 B2.

When the electronic device disclosed in JP 5865615 B2 is applied to a handheld display, a user using the handheld display typically holds the handheld display with their right hand and performs gestures with their left hand. In such a case, for example, if the user extends their right or left arm further, it may become difficult to stably hold the handheld display, and the operability during selection of an operation mode may be degraded.

### SUMMARY

Embodiments described herein are directed to technology for improving the operability of a display device.

In one embodiment, an information processing apparatus is configured to be communicatively connected to a display device that displays a spatial image including at least one of a real-space image and a virtual-space image and configured to process information communicated with the display device. The information processing apparatus includes at least one processor. The processor is configured or programmed to detect a movement of a hand of a user viewing the spatial image displayed on the display device, as a first detection result, and to detect a position of the hand, as a second detection result, in association with the acquisition of the first detection result. The processor is further configured or programmed to switch a function performed by the display device according to the first detection result and the second detection result.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of the functional configuration of an information processing system according to a first embodiment.

FIG. 2 is a block diagram illustrating an example of the hardware configuration of the information processing system.

FIGS. 3A and 3B are diagrams each illustrating a state in which a user performs a gesture while holding a display device, which is a handheld display.

FIG. 4 is a flowchart illustrating a process performed by an information processing apparatus.

FIG. 5 is a flowchart illustrating a process for setting a threshold used in the determination in step S403 of the flowchart illustrated in FIG. 4.

FIG. 6 is a diagram illustrating the relationship between a position where a gesture is performed (between a near end and a far end) and functions performed by the display device.

FIG. 7 is a diagram illustrating examples of the near end, the far end, and the position where a gesture is performed.

FIGS. 8A to 8C are diagrams each illustrating a state in which a user's hand is captured in an image taken by an image capturing unit of a display device according to a second embodiment.

FIG. 9 is a diagram illustrating an example of an image displayed on an image display unit of a display device according to a third embodiment.

FIGS. 10A and 10B are diagrams each illustrating a state in which a user performs a gesture while holding a display device according to a fourth embodiment.

FIG. 11 is a diagram illustrating a notification device that can be attached to and detached from a finger according to a fifth embodiment.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding parts, and duplicative descriptions thereof are omitted to avoid redundancy.

### First Embodiment

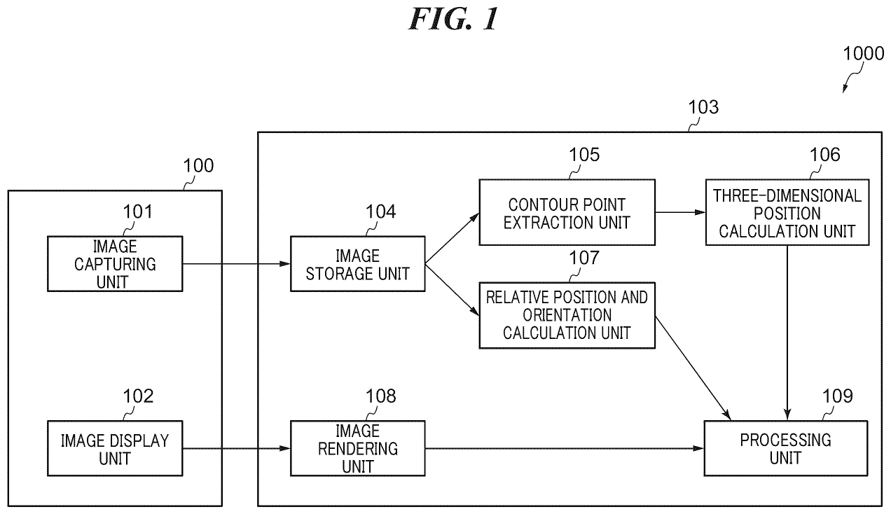

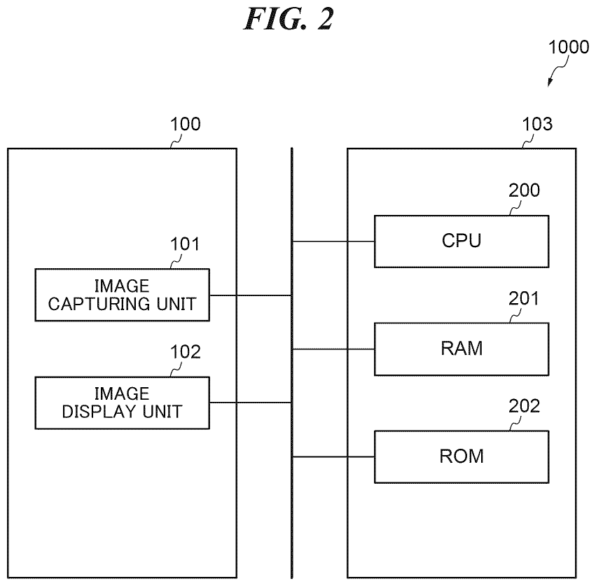

A first embodiment will be described below with reference to FIGS. 1 to 6. FIG. 1 is a block diagram illustrating an example of the functional configuration of an information processing system according to the first embodiment. FIG. 2 is a block diagram illustrating an example of the hardware configuration of the information processing system. As illustrated in FIGS. 1 and 2, an information processing system 1000 includes a display device 100 and an information processing apparatus 103, which are communicatively connected to each other. The communication between the display device 100 and the information processing apparatus 103 may be either wired or wireless. In this embodiment, the display device 100 and the information processing apparatus 103 are configured as separate devices; however, the embodiment is not limited thereto. For example, the information processing apparatus 103 may be incorporated in the display device 100.

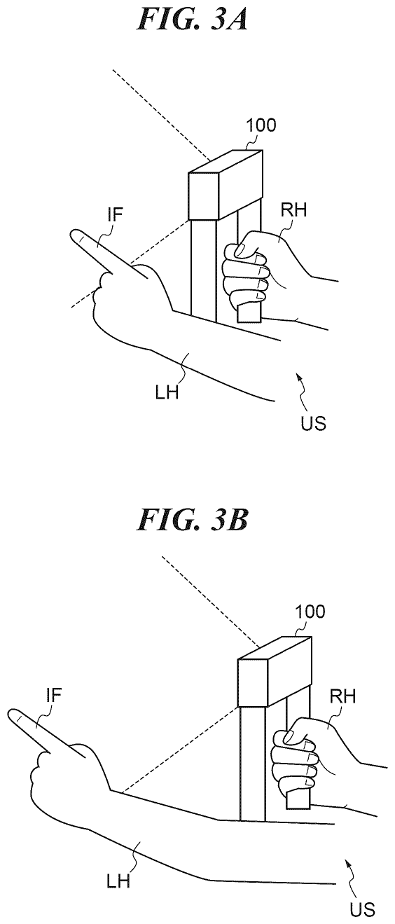

The display device 100 includes an image capturing unit (imager) 101 and an image display unit 102. The display device 100 is not particularly limited in type and may be, for example, a handheld display or a head-mounted display (HMD). A “handheld display” refers to a device that is held by at least one of the left hand LH and the right hand RH of a user US who views a spatial image displayed on the display device 100 (see FIGS. 3A and 3B). A “head-mounted display” refers to a device that is worn on the user's head. In this embodiment, the display device 100 will be described as a handheld display.

For example, when the user US holds the display device 100 (handheld display) with both hands in front of their face or chest and faces forward, the image capturing unit 101 captures an image of a real space in front of the user US, i.e., in the direction of the user's line of sight. The image of the real space is displayed as live footage on the image display unit 102 by a video see-through system. Note that the image display unit 102 is not limited to displaying images of a real space. For example, the image display unit 102 may also display images of a virtual space, as well as composite images that include both real-space and virtual-space images. In this manner, the image display unit 102 is configured to be capable of displaying a spatial image including at least one of a real-space image and a virtual-space image. Additionally, the real-space images or composite images include the left hand LH or the right hand RH of the user US, which is necessary for switching control that changes the function performed by the display device 100, as will be described later.

When the image display unit 102 displays a virtual-space image, the image capturing unit 101 is used to capture an image of the left hand LH or the right hand RH of the user US, which is necessary for the switching control. The image capturing unit 101 captures images of a real space at a predetermined frame rate (e.g., 30 frames per second). The image capturing unit 101 is configured as a stereo camera including a camera corresponding to the user's left eye and a camera corresponding to the user's right eye. Hereinafter, a pair of left and right images captured by the respective cameras may be referred to as a “stereo camera image.” The display device 100 with such a configuration is capable of performing multiple types of functions. The functions that can be performed by the display device 100 are not particularly limited and may include, for example, a menu screen display function, an image enlargement function (zoom function), and an image reduction function. The menu screen display function is a function to display a menu screen on the image display unit 102. The image enlargement function is a function to enlarge a spatial image displayed on the image display unit 102. The image reduction function is a function to reduce a spatial image displayed on the image display unit 102.

The information processing apparatus 103 is configured to process information communicated with the display device 100. The information processing apparatus 103 includes an image storage unit 104, a contour point extraction unit 105, a three-dimensional position calculation unit 106, a relative position and orientation calculation unit 107, an image rendering unit 108, and a processing unit 109. The information processing apparatus 103 also includes, as hardware components, a CPU 200, a RAM 201, and a ROM 202. The information processing apparatus 103 is not particularly limited in form and may be implemented, for example, as a desktop or notebook personal computer, a tablet, a smartphone, or the like.

The CPU 200 is a computer (controller) that controls the overall operation of the information processing system 1000. In this embodiment, the CPU 200 functions as each of the units from the image storage unit 104 to the processing unit 109; however, it is not limited thereto. For example, any of the functions of the image storage unit 104 to the processing unit 109 may be implemented separately from the CPU 200. The RAM 201 stores images captured by the image capturing unit 101 under the control of the image storage unit 104. The ROM 202 stores various programs in advance. The programs include, for example, a program that causes the CPU 200 to perform each of the steps (a method of controlling the information processing apparatus) described below.

The contour point extraction unit 105 performs image recognition processing on an image stored in the RAM 201, which includes the left hand LH or the right hand RH of the user US, to extract contour points of the hand and fingers.

The three-dimensional position calculation unit 106 calculates the three-dimensional positions, in the real space, of the contour points extracted by the contour point extraction unit 105. The x-coordinate and y-coordinate of each contour point are obtained based on the bottom-left corner of the VRAM region of the image containing the contour point, which is used as the origin (0, 0). Note that the origin of the coordinates is not limited to the bottom-left corner of the VRAM region of the image containing the contour point, and it may be arbitrarily set. The z-coordinate (i.e., the coordinate in the depth direction) of the contour point is obtained from a stereo camera image.

In order to accurately display the depth of the hand, it is also possible to extract the region of the hand from an image of the hand captured by the stereo camera, and to calculate a depth value of the hand relative to the stereo camera. In this case, depth values may be obtained through triangulation for all corresponding points of extracted hand contour lines in the stereo camera image (see, for example, JP 2012-013514 A mentioned above). Alternatively, “Leap Motion” (registered trademark) by Leap Motion, Inc. may also be used. The Leap Motion can detect the region of the hand through its stereo camera (corresponding to the image capturing unit 101). In addition, a depth sensor may be installed in the display device 100, and the positions and orientations of the hand and fingers may be estimated using the depth sensor. In this embodiment, one arbitrary point is selected from among the plurality of contour points extracted by the contour point extraction unit 105, and the three-dimensional positions of the other contour points relative to the selected point are calculated. The selected point may be stored as a reference position and may be periodically updated in conjunction with the movement of the hand and fingers.

The relative position and orientation calculation unit 107 calculates the position and orientation of the left hand LH or the right hand RH of the user US included in an image stored in the RAM 201. The position and orientation can be calculated through methods such as those using deep learning or using existing publicly available libraries.

The processing unit 109 identifies the types of gestures based on changes in the coordinate values calculated by the three-dimensional position calculation unit 106. The relationship between the types of gestures and the functions performed by the display device 100 is stored in advance in the ROM 202. Note that additional types of gestures may be stored in the ROM 202 as needed. Such additions may be made, for example, through a settings menu. The coordinate values calculated by the three-dimensional position calculation unit 106 may include errors. In such a case, for example, an error rate of up to 5 percent may be set as an allowable error rate.

The image rendering unit 108 renders an image to be displayed on the image display unit 102 of the display device 100 based on the processing result of the processing unit 109.

FIGS. 3A and 3B are diagrams each illustrating a state in which a user performs a gesture while holding a display device, which is a handheld display. FIG. 3A illustrates a state in which the user US performs a gesture with the left hand LH (moves the left hand LH) while holding the display device 100 with the right hand RH. FIG. 3B illustrates a state in which the user US performs a gesture with the left hand LH extended farther than in the state of FIG. 3A while holding the display device 100 with the right hand RH. With reference to FIGS. 3A and 3B, the index finger IF of the left hand LH is located closer to the display device 100 in the state illustrated in FIG. 3A, while it is located farther from the display device 100 in the state illustrated in FIG. 3B. As a result, the distance between the index finger IF (left hand LH) and the display device 100 changes.

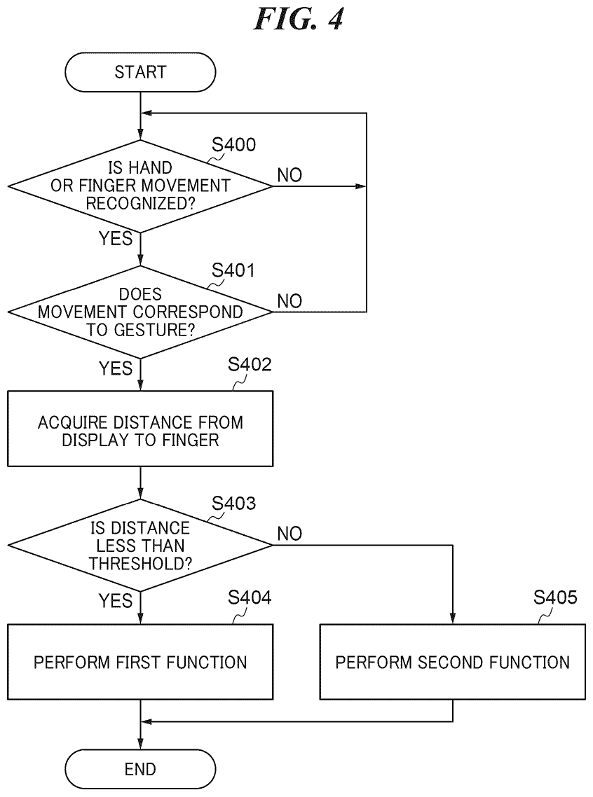

FIG. 4 is a flowchart illustrating a process performed by the information processing apparatus. As illustrated in FIG. 4, in step S400, the three-dimensional position calculation unit 106 of the information processing apparatus 103 calculates the three-dimensional positions (coordinates) of the contour points extracted by the contour point extraction unit 105. The processing unit 109 determines whether the movement of the left hand LH or the right hand RH of the user US or the movement of any finger of the left hand LH or the right hand RH has been recognized based on changes in the three-dimensional positions calculated by the three-dimensional position calculation unit 106.

Note that a human's hands and fingers do not come to a complete rest while they are awake. Therefore, a threshold may be set for determining the presence or absence of hand or finger movement so that the information processing apparatus 103 can determine whether the hand or fingers are being intentionally moved. This threshold can be arbitrarily set and modified. The threshold may be modified or changed, for example, by operating a keyboard or the like of the information processing apparatus 103. If it is determined in step S400 that the movement of the hand or fingers has been recognized, the process proceeds to step S401. On the other hand, if it is determined in step S400 that the movement of the hand or fingers has not been recognized, the process remains in a standby state at step S400.

In step S401, the processing unit 109 determines whether the movement of the hand or finger (hereinafter representatively referred to as “finger”) recognized in step S400 corresponds to any of the types of gestures stored in advance in the ROM 202. If it is determined in step S401 that the movement corresponds to one of the types of gestures, the process proceeds to step S402. On the other hand, if it is determined in step S401 that the movement does not correspond to any of the types of gestures, the process returns to step S400, and the subsequent steps are performed in order. In this manner, the processing unit 109 of this embodiment also functions as a first detector that detects, as a first detection result, a gesture in the form of hand or finger movement by the user US. Note that, in the information processing apparatus 103, a component that functions as the first detector may be provided separately from the processing unit 109.

In step S402, the processing unit 109 acquires the distance from the display device 100 to the finger that is the subject of the determination in step S400 based on the three-dimensional position of the finger. As this distance, a depth value of the finger, which is calculated using a stereo camera image including the finger, may be used. The distance in step S402 may alternatively be acquired by using, for example, an image captured by a time-of-flight (TOF) camera as a distance map. In this manner, the processing unit 109 of this embodiment also functions as a second detector that detects, as a second detection result, the separation distance (position) of the finger relative to the display device 100 in association with the gesture detection in step S401. Note that, in the information processing apparatus 103, a component that functions as the second detector may be provided separately from the processing unit 109.

In step S403, the processing unit 109 determines whether the distance acquired in step S402 is less than a threshold (described later). If it is determined in step S403 that the distance is less than the threshold, the process proceeds to step S404. On the other hand, if it is determined in step S403 that the distance is not less than the threshold, i.e., the distance is equal to or greater than the threshold, the process proceeds to step S405.

In step S404, the processing unit 109 causes the display device 100 to perform a first function. The first function is not particularly limited and may be, for example, the menu screen display function, which is one of the plurality of functions that can be performed by the display device 100 as described above.

In step S405, the processing unit 109 causes the display device 100 to perform a second function. The second function is not particularly limited and may be, for example, the image enlargement function. In this manner, the processing unit 109 of this embodiment also functions as a switching unit that switches the function performed by the display device 100 according to the determination result (first detection result) in step S401 and the determination result (second detection result) in step S403. Specifically, when a gesture is detected in step S401 and the distance is determined to be less than the threshold in step S403, the processing unit 109 switches the function performed by the display device 100 to the menu screen display function (first function) among the plurality of functions.

When a gesture is detected in step S401 and the distance is determined not to be less than the threshold in step S403, the processing unit 109 switches the function performed by the display device 100 to the image enlargement function (second function), which is different from the menu screen display function. Note that, in the information processing apparatus 103, a component that functions as the switching unit may be provided separately from the processing unit 109. Additionally, in this embodiment, two functions, i.e., the menu screen display function and the image enlargement function, are assigned to a single gesture; however, the embodiment is not limited thereto. For example, three or more functions may be assigned to a single gesture. If three functions are assigned to a single gesture, two thresholds are required.

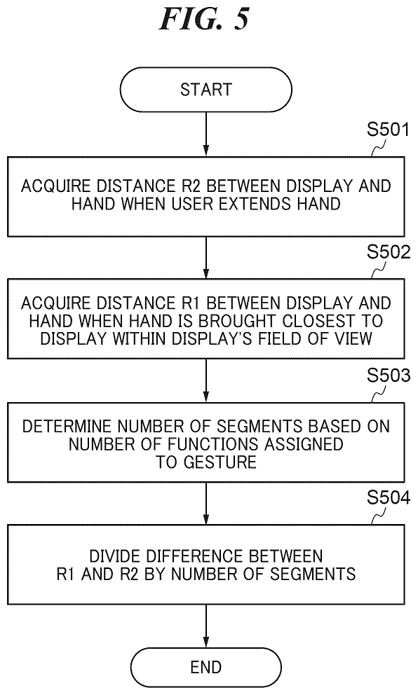

FIG. 5 is a flowchart illustrating a process for setting a threshold used in the determination in step S403 of the flowchart illustrated in FIG. 4. This process can be performed by the information processing apparatus 103. As illustrated in FIG. 5, in step S501, the processing unit 109 of the information processing apparatus 103 acquires the distance R2 between the display device 100 and the left hand LH (or the right hand RH) when the user US fully extends the left hand LH (or the right hand RH). The distance R2 may be acquired in the same manner as the distance acquisition in step S402. Hereinafter, the position of the left hand LH at the distance R2 is referred to as the “far end.”

In step S502, the processing unit 109 acquires the distance R1 between the display device 100 and the left hand LH when the user US extends the left hand LH to the position closest to the display device 100 within the field of view of the image capturing unit 101 of the display device 100. The distance R1 may also be acquired in the same manner as the distance acquisition in step S402. Hereinafter, the position of the left hand LH at the distance R1 is referred to as the “near end.”

In step S503, the processing unit 109 sets the number of functions assigned to a single gesture as the number of segments into which the hand movement range is divided. The difference between the distance R1 and the distance R2 defines the range in which functions can be performed by the gesture. For example, the distance R1 is calculated by the following Equation (1), with the position of the display device 100 as the starting point. In Equation (1), X1, Y1, and Z1 represent the coordinates of the near end. Similarly, the distance R2 is calculated by the following Equation (2), with the position of the display device 100 as the starting point (X0, Y0, Z0). In Equation (2), X2, Y2, and Z2 represent the coordinates of the far end.

$$\begin{matrix}[ Equation ] & \\ R 1 = \sqrt{X {1}^{2} + Y {1}^{2} + Z {1}^{2}} & ( 1 )\end{matrix}$$

$$R 2 = \sqrt{X {2}^{2} + Y {2}^{2} + Z {2}^{2}} \qquad ( 2 )$$

In step S504, the processing unit 109 divides the difference between the distance R1 and the distance R2 by the number of segments set in step S503. A threshold (distance R1+distance Ra) can be set based on the result of the calculation in step S504.

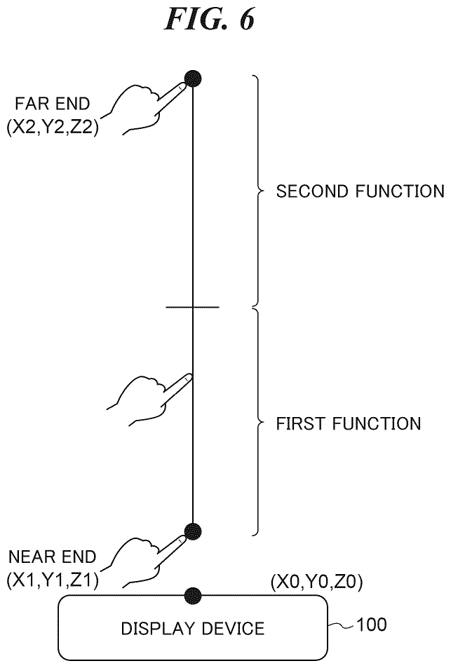

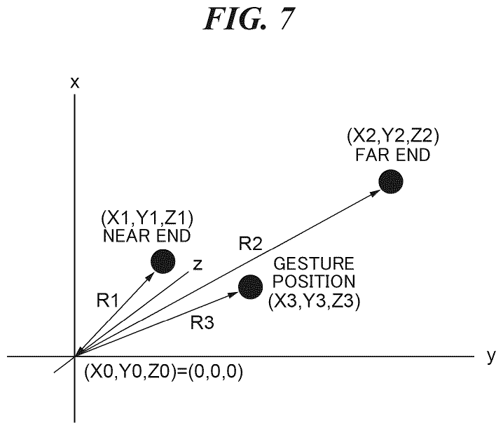

FIG. 6 is a diagram illustrating the relationship between a position where a gesture is performed (between the near end and the far end) and functions performed by the display device. FIG. 7 is a diagram illustrating examples of the near end, the far end, and the position where a gesture is performed. For example, suppose that the functions assigned to gesture A are the first function and the second function. When the distance R3 from the display device 100 to the point where gesture A is performed is less than the threshold (distance R1+distance Ra), the first function is performed. When the distance from the display device 100 to the point where gesture A is performed is equal to or greater than the threshold (distance R1+distance Ra), the second function is performed. The distance Ra is calculated by the following Equation (3). Equation (3) is an example in which the number of segments set in step S503 is “2,” and the difference between the distance R1 and the distance R2 is divided by “2.” The distance R3 is calculated by the following Equation (4). In Equation (4), X3, Y3, and Z3 represent the coordinates of the point where gesture A is performed.

$$\begin{matrix}[ Equation ] & \\ Ra = \frac{( R 2 - R 1 )}{2} & ( 3 )\end{matrix}$$

$$R 3 = \sqrt{X {3}^{2} + Y {3}^{2} + Z {3}^{2}} \qquad ( 4 )$$

In the information processing system 1000 (information processing apparatus 103) configured as described above, for example, the user US can perform a gesture with the left hand LH while holding the display device 100 with the right hand RH. The function performed by the display device 100 can be changed according to the position of the gesture performed by the left hand LH relative to the display device 100. This makes it possible to improve the operability of the display device 100. Note that the threshold may be determined, for example, based on the average human arm length or an arm length measured in advance.

### Second Embodiment

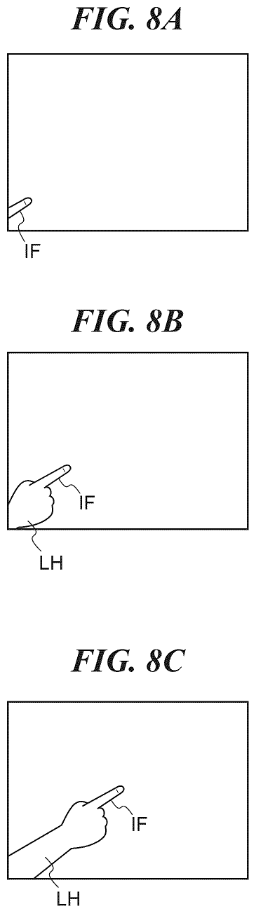

A second embodiment will be described below with reference to FIGS. 8A to 8C, focusing on differences from the previously described embodiment without repeating the same explanations. FIGS. 8A to 8C are diagrams each illustrating a state in which a user's hand is captured in an image taken by the image capturing unit of the display device according to the second embodiment. FIG. 8A illustrates an image that captures the index finger IF of the left hand LH of the user US. FIG. 8B illustrates an image that captures the index finger IF to the wrist of the left hand LH of the user US. FIG. 8C illustrates an image that captures the index finger IF to the forearm of the left hand LH of the user US. For example, the distance from the display device may be defined as follows: when in the state illustrated in FIG. 8B, the left hand LH is considered to be at the near end, and when in the state illustrated in FIG. 8C, the left hand LH is considered to be at the far end. In this embodiment, the near end and the far end can thus be set based on the extent to which the hand is captured in the image taken by the image capturing unit 101 of the display device 100, that is, according to the length (or size) of the hand appearing in the image. Accordingly, the threshold can be determined based on the near end and the far end as described above.

### Third Embodiment

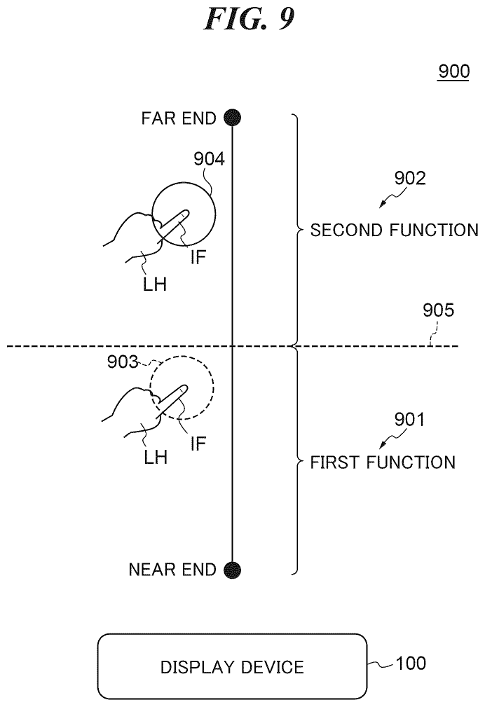

A third embodiment will be described below with reference to FIG. 9, focusing on differences from the previously described embodiments without repeating the same explanations. FIG. 9 is a diagram illustrating an example of an image displayed on the image display unit of the display device according to the third embodiment. As illustrated in FIG. 9, an image 900 includes the left hand LH, a first function display section 901, and a second function display section 902. The first function display section 901 indicates that, when the left hand LH is located on the near side, the function performed by the display device 100 can be switched to the first function. The second function display section 902 indicates that, when the left hand LH is located on the far side, the function performed by the display device 100 can be switched to the second function. The image 900 is displayed on the image display unit 102 of the display device 100 under the control of the CPU 200 of the information processing apparatus 103.

When the left hand LH is located on the near side, i.e., when the function performed by the display device 100 can be switched to the first function, the index finger IF of the left hand LH may be enclosed by a dashed circle 903. Similarly, when the left hand LH is located on the far side, i.e., when the function performed by the display device 100 can be switched to the second function, the index finger IF of the left hand LH may be enclosed by a solid circle 904. With such enclosures, the user US can more reliably recognize which of the first function and the second function the display device 100 can currently be switched to. Note that the indication of the switchable function is not limited to enclosing the finger with a circle, and may alternatively be implemented by coloring. The image 900 may also include a boundary line 905. The boundary line 905 is a line that the left hand LH crosses when switching occurs from one function to the other between the first function and the second function. The boundary line 905 allows the user US to recognize the timing at which the function performed by the display device 100 is switched. Although the boundary line 905 is illustrated as a dashed line in FIG. 9, it is not limited thereto.

### Fourth Embodiment

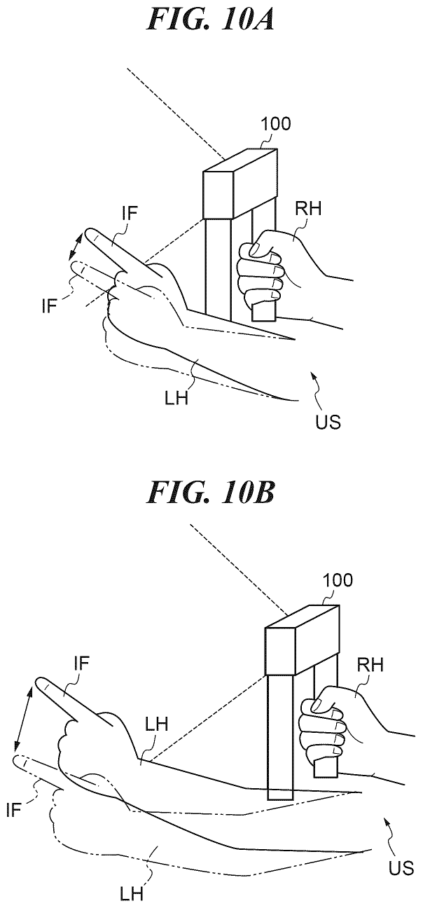

A fourth embodiment will be described below with reference to FIGS. 10A and 10B, focusing on differences from the previously described embodiments without repeating the same explanations. FIGS. 10A and 10B are diagrams each illustrating a state in which a user performs a gesture while holding the display device according to the fourth embodiment. FIG. 10A illustrates a state in which the user US performs a relatively small gesture with the left hand LH while holding the display device 100 with the right hand RH. FIG. 10B illustrates a state in which the user US performs a larger gesture with the left hand LH extended farther than in the state of FIG. 10A while holding the display device 100 with the right hand RH. The gesture illustrated in FIG. 10A and the gesture illustrated in FIG. 10B may both be assigned, for example, the image enlargement function. It may be easier for the user US to perform a larger gesture when the left hand LH is extended farther. On the other hand, to reliably recognize a relatively small (subtle) gesture, it is preferable for the left hand LH to be closer to the display device 100. In this embodiment, the type of gesture and the function performed by the display device 100 can be associated (linked) in consideration of both the case of performing the gesture for the user US and the stability of gesture recognition.

### Fifth Embodiment

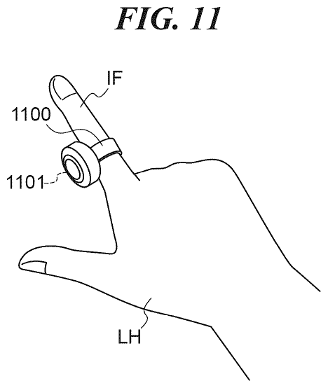

A fifth embodiment will be described below with reference to FIG. 11, focusing on differences from the previously described embodiments without repeating the same explanations. FIG. 11 is a diagram illustrating a notification device that can be attached to and detached from a finger according to the fifth embodiment. As illustrated in FIG. 11, a communication device 1100 is a ring-shaped device that is worn, for example, on the index finger IF of the left hand LH. The communication device 1100 is internally equipped with a GPS 1101, for example, and is communicatively connected to the information processing apparatus 103. This enables the determination in step S401, i.e., the detection of the gesture of the left hand LH, to be performed more accurately based on communication information from the communication device 1100. In addition, the distance in step S402, i.e., the position of the left hand LH, can also be detected more accurately based on communication information from the communication device 1100. Although the communication device 1100 of this embodiment is a ring-type device, it is not limited thereto. For example, the communication device 1100 may be a glove-type device that can be removably worn on the hand.

According to the embodiments described above, the operability of the display device can be improved.

The above embodiments may be implemented using a combination of a general-purpose processor and a dedicated processor. Note that the term “processor” as used herein refers to a processor in a broad sense, encompassing both general-purpose processors and dedicated processors. The operations and processes according to the above embodiments may be implemented by a single processor or through the cooperation of multiple processors that are installed in physically separate locations. Additionally, although the display device 100 has been described as a handheld display in the above embodiments, it is not limited thereto. The display device 100 may instead be a head-mounted display.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-172384, filed Oct. 1, 2024, which is hereby incorporated by reference herein in its entirety.

What is claimed is:

1. An information processing apparatus configured to be communicatively connected to a display device that displays a spatial image including at least one of a real-space image and a virtual-space image and configured to process information communicated with the display device, the information processing apparatus comprising one or more processors configured to:
detect, as a first detection result, a movement of a hand of a user viewing the spatial image displayed on the display device using the display device;
detect, as a second detection result, a position of the hand in association with acquisition of the first detection result; and
switch a function performed by the display device according to the first detection result and the second detection result.

2. The information processing apparatus according to claim 1, wherein a hand gesture is detected as the first detection result.

3. The information processing apparatus according to claim 1, wherein a distance between the hand and the display device is detected as the second detection result.

4. The information processing apparatus according to claim 1, wherein
the function performed by the display device include a plurality of functions,
a hand gesture is detected as the first detection result,
a distance between the hand and the display device is detected as the second detection result,
when the hand gesture is detected and the detected distance is less than a threshold, the function performed by the display device is switched to a first function, which is one of the plurality of functions, and
when the hand gesture is detected and the detected distance is equal to or greater than the threshold, the function performed by the display device is switched to a second function, which is one of the plurality of functions and is different from the first function.

5. The information processing apparatus according to claim 4, wherein the one or more processors are further configured to change the threshold.

6. The information processing apparatus according to claim 4, wherein the one or more processors are further configured to:
cause the display device to display an indication that switching to the first function is possible when the function performed by the display device becomes switchable to the first function, and
cause the display device to display an indication that switching to the second function is possible when the function performed by the display device becomes switchable to the second function.

7. The information processing apparatus according to claim 4, wherein the one or more processors are further configured to cause the display device to display a boundary line that the hand crosses when the function performed by the display device is switched between the first function and the second function.

8. The information processing apparatus according to claim 7, wherein the one or more processors are further configured to cause the display device to display the boundary line when the hand is moving.

9. The information processing apparatus according to claim 1, wherein
the display device includes an imager configured to capture an image of the hand, and
the one or more processors are further configured to:
detect, as the first detection result, the movement of the hand based on the image of the hand; and
detect, as the second detection result, the position of the hand based on the image of the hand.

10. The information processing apparatus according to claim 1, wherein
a communication device that is communicatively connected to the information processing apparatus is worn on the hand, and
the one or more processors are further configured to:
detect, as the first detection result, the movement of the hand based on communication information from the communication device;
detect, as the second detection result, the position of the hand based on communication information from the communication device.

11. The information processing apparatus according to claim 1, wherein the display device is a head-mounted display configured to be worn on the user's head or a handheld display configured to be held by at least one of the user's left and right hands.

12. A method of controlling an information processing apparatus communicatively connected to a display device that displays a spatial image including at least one of a real-space image and a virtual-space image and configured to process information communicated with the display device, the method comprising:
detecting, as a first detection result, a movement of a hand of a user viewing the spatial image displayed on the display device using the display device;
detecting, as a second detection result, a position of the hand in association with acquisition of the first detection result; and
switching a function performed by the display device according to the first detection result and the second detection result.

13. A non-transitory computer-readable medium comprising computer-executable instructions stored thereon that, when executed by a computer, cause the computer to perform a method of controlling an information processing apparatus, the information processing apparatus being communicatively connected to a display device that displays a spatial image including at least one of a real-space image and a virtual-space image and being configured to process information communicated with the display device, the method comprising:
detecting, as a first detection result, a movement of a hand of a user viewing the spatial image displayed on the display device using the display device;
detecting, as a second detection result, a position of the hand in association with acquisition of the first detection result; and
switching a function performed by the display device according to the first detection result and the second detection result.
